(19) United States
(12) Patent Application Publication
(10) Pub. No.: US 2009/0211123 A1
(43) Pub. Date: Aug. 27, 2009

(54) DEVICE FOR PROVIDING A MAGNETIC SURFACE

(76) Inventors: MARY MASSARUTO ARNOLD, Coral Gables, FL (US); David Jack Arnold, Coral Gables, FL (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(21) Appl. No.: 12/390,240

(22) Filed: Feb. 20, 2009

Related U.S. Application Data
(60) Provisional application No. 61/067,392, filed on Feb. 21, 2008.

(51) Int. Cl. G09F 15/00

(52) U.S. Cl. 40/1

(57) ABSTRACT

A device generally intended to be used for providing a magnetic surface that can be temporarily attached to a non-magnetic surface. The device includes a board element and an attachment assembly. The attachment assembly can be, for example, suction or adhesive based, and can enable the board element to be attached to many substantially flat surfaces. The board element can include a piece of sheet steel or a composite of sheet steel and other suitable structural materials. One or more surfaces of the board element can be coated to provide a smooth non-porous surface. The non-porous surface can enable the use of, among other things, dry-erase markers and other erasable writing implements.

### CROSS REFERENCE TO RELATED APPLICATION

This application claims benefit under 35 USC § 119(e) of U.S. Provisional Patent Application Ser. No. 61/067,392 filed 21 Feb. 2008 which application is hereby incorporated fully by reference.

### BACKGROUND OF THE INVENTION

1. Field of the Invention

The present invention relates generally to a device for providing a smooth, magnetic surface on otherwise non-ferrous materials, and in particular, to a coated steel panel with temporary attachment means for use on stainless steel appliances.

2. Description of Related Art

Refrigerators have long been a favorite location for the display of a variety of items. The refrigerator is a common location for pictures, reports cards, drawings, and other keepsakes. The refrigerator is also a convenient location to attach messages, notes, take-out menus, and shopping lists.

One reason the refrigerator is a popular place for such items is because, conventionally, refrigerators were made from painted or coated steel, which is a “soft” ferromagnetic material. This means that, unlike the permanent magnets, steel is attracted to magnets, but does not tend to stay magnetized. The large, substantially flat steel surface of a refrigerator, coupled with a few permanent magnets (those generally used for refrigerator magnets), makes for a convenient bulletin board with a temporary attachment means. When not in use, the magnet is easily removed and leaves little or no evidence of its previous placement behind.

The refrigerator magnet itself is somewhat ubiquitous in the American household. Many people collect the magnets themselves. Refrigerator magnets come in a variety of shapes, sizes, and materials and are offered in a wide variety of settings. Magnets can be a souvenir bought on a trip or brought back as a memento of a special occasion. In addition, there are games and puzzles tailored specifically to the magnetic surface of a refrigerator. One such product is Magnetic Poetry®, which provides words printed on small magnets, and enables one to create poetry on the refrigerator.

The significant rise in the popularity of stainless steel appliances in recent years, however, has been troublesome for those with a penchant for refrigerator magnets. This is because most types of stainless steel (“SS”) have little or no attraction to magnets. SS, sometimes referred to as corrosion resistant steel or CRES, is a form of steel that has at least 10% chromium content, but can include up to 27% chromium. SS is not, as the name implies, stainless; it is, however, highly resistant to staining and discoloring in most circumstances due to the high chromium content.

With more conventional carbon steel, the iron in the steel reacts with air and moisture to form iron oxide, commonly referred to as “rust.” The rust is itself reactive and, therefore, continues to form in ever increasing amounts until all of the iron is consumed. As a result, steel products not properly protected can “rust through,” or can literally turn to dust.

When chromium is added to steel to make SS, it forms an outer coating of chromium oxide on the steel which prevents further surface corrosion and blocks corrosion from spreading into the metal's internal structure. The layer of chromium oxide is too thin to be seen with the naked eye however, thus SS generally has a lustrous surface appearance. Additionally, if the surface of SS is scratched, the chromium oxide layer quickly reforms protecting the underlying metal. This makes an ideal surface for many applications, particularly the kitchen where durability and cleanability are paramount.

Ferritic SS contains between 10-27% chromium and can contain trace amounts of other metals. It is very corrosion resistant, but somewhat less durable than other forms of SS due to its body center cubic crystalline structure. As a result, nickel is often added to SS. Nickel stabilizes and hardens the molecular structure of the SS into an austenitic crystalline form. The crystals make the SS more stable and less brittle at low temperature, but they also make the structure non-magnetic.

Herein lies the problem, because over 70% of overall SS production is austenitic steel, including most SS kitchen appliances. Refrigerators, dishwashers, and ovens, among other appliances, are commonly available in this type of SS. Unfortunately, this means that almost all SS appliances are non-magnetic precluding the use of refrigerator magnets thereon.

What is needed, therefore, is a magnetic surface that can be temporarily attached to non-magnetic surfaces. This device should be easily and securely attachable to substantially flat surfaces and should be removable without damaging or marking the underlying surface. Additionally, the device should be a simple and cost-effective solution to this ubiquitous problem. It is to such a device that embodiments of the present invention are primarily directed.

### BRIEF SUMMARY OF THE INVENTION

Briefly described, the present invention is a device for providing a removable substantially magnetic surface on a substantially non-magnetic surface. As used herein, the terms magnetic and non-magnetic include substantially magnetic and substantially non-magnetic, respectively. The present invention can comprise a board element with a first surface and a second surface. The first surface and the second surface can be disposed on opposite sides of the board element. The present invention can further comprise an attachment means for attaching the second surface to a non-magnetic surface in a removable, non-marring manner, such that the second surface and the non-magnetic surface are disposed in a substantially parallel and opposing manner. In some embodiments, the board element can comprise steel. In other embodiments, the first surface can comprise steel, and the second surface can comprise a rigid, non-magnetic material.

In some embodiments, the attachment means can comprise one or more suction cups affixed to the second surface of the board element. In other embodiments, the attachment means can comprise a removable adhesive. In still other embodiments, the attachment means can comprise one or more hooks.

In an exemplary embodiment, the first surface, the second surface, or both can further comprise a smooth, non-porous coating. In some embodiments, the board element can comprise a polygon, circle, star, oval, or many other shapes. The present invention can further comprise one or more fasteners inserted through one or more mounting holes in the board element for affixing the attachment means to the second surface of the board element.

In an alternative embodiment, the present invention is a device for providing a removable magnetic surface on a non-magnetic surface comprising a board element, which can comprise a first surface and a second surface with the first surface and the second surface disposed on opposite sides of the board element. The present invention can further comprise, one or more suction cups for attaching the second surface to a non-magnetic surface such that the second surface and the non-magnetic surface are disposed in a substantially parallel and opposing manner.

In some embodiments, the suctions cups can be affixed to the second surface using an adhesive. In other embodiments, one or more fasteners can be inserted through one or more mounting holes in the board element for affixing the attachment means to the second surface of the board element. In still other embodiments, the fasteners can affix the suction cups to the second surface in a detachable manner.

In yet further embodiments, the present invention can include a kit, comprising a device for providing a removable magnetic surface on a non-magnetic surface, and magnetic pieces useable on the removable magnetic surface.

In still other embodiments the present invention can comprise a method for providing a magnetic surface on a non-magnetic surface comprising providing a board element with a first surface and a second surface, covering one or both of the first surface and the second surface with a smooth, non-porous coating, and providing a fastening means for detachably affixing the second surface of the board element to a non-magnetic surface. In some embodiments, the fastening means can comprise a non-permanent adhesive. In other embodiments, the board element can comprise steel.

In an exemplary embodiment, the method can further comprise providing a sheet of steel for the first surface, providing a rigid, non-magnetic sheet for the second surface, and affixing the first surface to the second surface to form the board element. In some embodiments, the fastening means can comprise one or more suction cups. In other embodiments, the smooth, non-porous coating can be selected from the group consisting of powder-coating, paint, plastic, enamel, melamine, ceramic, zinc, aluminum, nickel, and chrome. In other embodiments, the smooth, non-porous coating can be compatible for use with dry erase marking utensils.

### BRIEF DESCRIPTION OF THE FIGURES

FIG. 1 illustrates a front view of a device for providing a magnetic surface in accordance with some embodiments of the present invention.

FIG. 2 illustrates a perspective view of a device for providing a magnetic surface in accordance with some embodiments of the present invention.

FIG. 3 illustrates a perspective view of a device for providing a magnetic surface in accordance with some embodiments of the present invention.

FIG. 4 illustrates a perspective view of a device for providing a magnetic surface in accordance with some embodiments of the present invention.

FIG. 5 illustrates a front view of a device for providing a magnetic surface in accordance with some embodiments of the present invention.

FIG. 6 illustrates a cross-sectional view of a device for providing a magnetic surface in accordance with some embodiments of the present invention.

FIG. 7A illustrates a cross-sectional, detailed view of a device for providing a magnetic surface in accordance with some embodiments of the present invention.

FIG. 7B illustrates a cross-sectional, detailed view of a device for providing a magnetic surface in accordance with some embodiments of the present invention.

FIG. 8 illustrates a perspective view of a device for providing a magnetic surface in accordance with some embodiments of the present invention.

FIG. 9 illustrates a perspective view of a portion of the attachment means for a device for providing a magnetic surface in accordance with some embodiments of the present invention.

FIG. 10 illustrates a perspective view of a device for providing a magnetic surface in accordance with some embodiments of the present invention.

### DETAILED DESCRIPTION OF PREFERRED EMBODIMENT

To facilitate an understanding of the principles and features of embodiments of the invention, they are explained hereinafter with reference to implementations in illustrative embodiments. Embodiments of the invention are described in the context of being a device and method for providing a magnetic surface on a non-magnetic surface and in particular, to providing a magnetic surface for use on non-magnetic stainless steel appliances.

Embodiments of the invention, however, are not solely limited to use with stainless steel appliances. Rather, embodiments of the invention can be used wherever a smooth, substantially flat magnetic surface is needed or desired.

The material described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example.

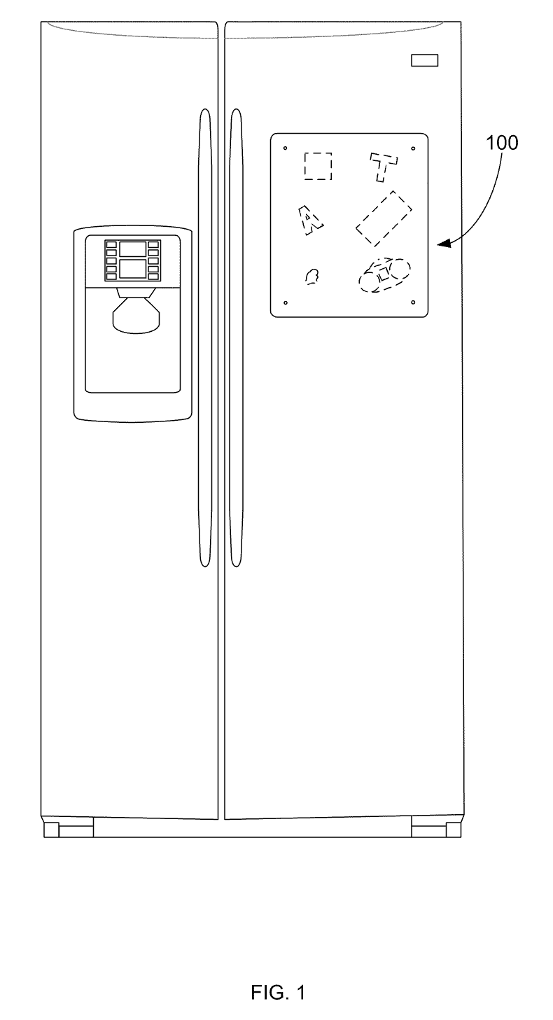

Referring now in detail to the drawings, wherein like reference numerals represent like parts throughout the several views, the present invention of FIG. 1 is a device 100 that provides a ferromagnetic (“magnetic”) surface that can be temporarily attached to non-magnetic surfaces in accordance with an exemplary embodiment of the invention. In some embodiments, portions of the device 100 can be coated with a surface coating to prevent rust and to provide a smooth surface thereon. In other embodiments, the device 100 can also provide a surface suitable for use with dry erase or other erasable writing utensils. The device 100 can be attached using a variety of non-permanent, non-marring attachment means. The device 100 can comprise a magnetic material, or can comprise a composite material with a magnetic layer.

As depicted in FIG. 1, in some embodiments, the device 100 can be attached to a refrigerator. This can be desirable, for example, because the surface of the refrigerator is manufactured from a non-magnetic material, such as stainless steel (“SS”). This can be desirable to provide a surface to which conventional refrigerator magnets are attracted. The device 100 is not, however, limited to use on refrigerators and can be attached to a variety of surfaces using an appropriate attachment means.

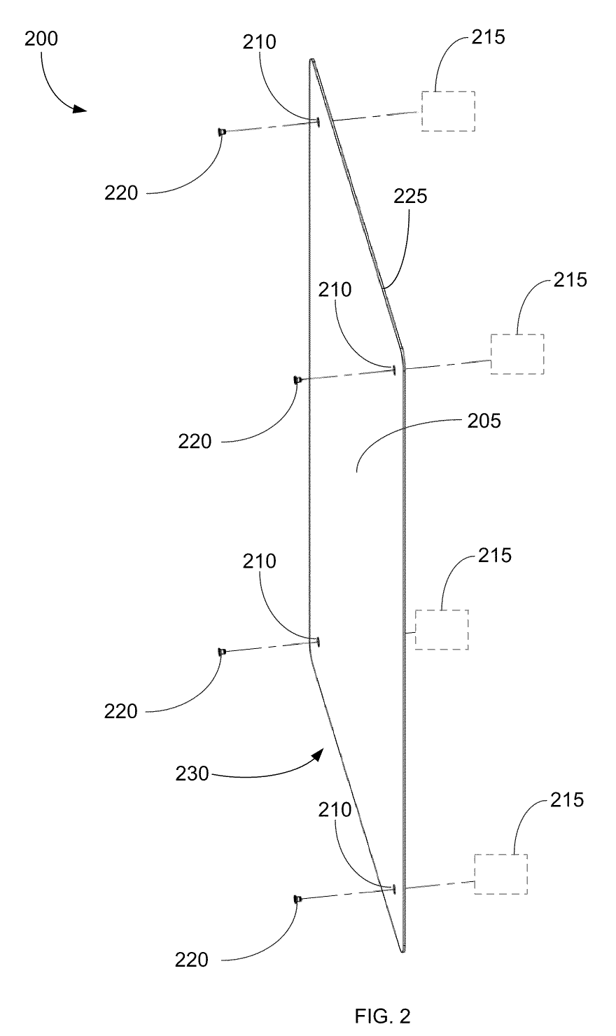

FIG. 2 is a perspective view of an exemplary embodiment of the device 200. FIG. 2 depicts a rectangular embodiment of the present invention; however, the invention is not so limited. The device 200 can be, for example and not limitation, triangular, ovoid, circular, octagonal, or hexagonal. The device 200 can comprise a board element 230, one or more mounting holes 210, one or more attachment means 215, and one or more fastening means 220. The board element can further comprise a first surface 205 and a second surface 225.

In some embodiments, the attachment means 215 can enable the second surface 225 (not visible) of the board element 230 to be temporarily, yet firmly, attached to the desired surface in a non-magnetic manner. The attachment means 215 can also enable the board element 230 to be removed therefrom without damaging either surface, i.e., the second surface 225 of the board element 230 or the surface to which the board element 230 is attached. The attachment means can be, for example and not limitation, suctions cups, removable tape, fugitive adhesives, 3M Command™ strips, and adhesive putties.

In other embodiments, the attachment 215 means can comprise hooks suitable for hanging the board element 230. This can enable the board element 230 to be suspended from, for example and not limitation, the top of a door, a window sill, or the edge of a counter. In still other embodiments, the attachment means 215 can comprise rare earth magnets. Rare earth magnets generally create magnetic attraction that is too strong for practical use. However, due to the substantially non-magnetic nature of stainless steel, properly sized rare earth magnets can enable the board element 230 to be magnetically adhered to a substantially non-magnetic appliance or other surface comprising stainless steel.

In still other embodiments, attachment means 215 can be provided on the refrigerator by the manufacturer. In other words, clips, hooks, snaps or other attachment means 215 can be provided on the refrigerator during manufacture with complementary attachment means 215 located on the device 100. The attachment means 215 can be located, for example and not limitation, on the surface or edge of the door of the appliance. This placement can enable the attachment means 215 to be unobtrusive when not in use. This feature can allow manufacturers, retailers, or aftermarket providers to offer consumers an accessory that provides a removable magnetic and/or dry erase surface on stainless steel appliances, other appliances, or surfaces. The device 100 can be supplied with an appliance, sold as an upgrade, or can be sold as a distinct product.

In other embodiments, a fastening means 220 can be used to affix the attachment means 215 to the second surface 225 of the board element 230. This can be desirable, for example, if the attachment means 215 is not adhesive in nature. The fastening means 220 can be, for example and not limitation, rivets, screws, bolts, or pins. The fastening means 220 can pass through one or more mounting holes 210 in the board element 230 and affix the attachment means 215 to the second surface 225 of the board element 230.

In some embodiments, one, or both of the surfaces 205, 225 of the board element 230 can be covered with a smooth, non-porous surface coating. In some embodiments, the board element 230 can be powder coated to provide a durable, non-porous surface. In other embodiments, the board element 230 can be coated, for example and not limitation, in plastic, lacquer, enamel, resin, urethane, latex, or other suitable means.

Coating the board element 230 can prevent corrosion of, and damage to, the underlying surface. In some embodiments, the coating can provide a smooth, non-porous surface that enables the use of dry erase markers, or other erasable writing tools, on the first surface 205 of the board element 230. In still other embodiments, the surface can be coated for aesthetic purposes such as, for example and not limitation, adding a design or logo; providing color, stripes, or color matching; or providing a template for lists or other purposes. In still other embodiments the first surface 205 and the second surface 225 can be coated with different surface coatings or the same type of coating with a different color or texture.

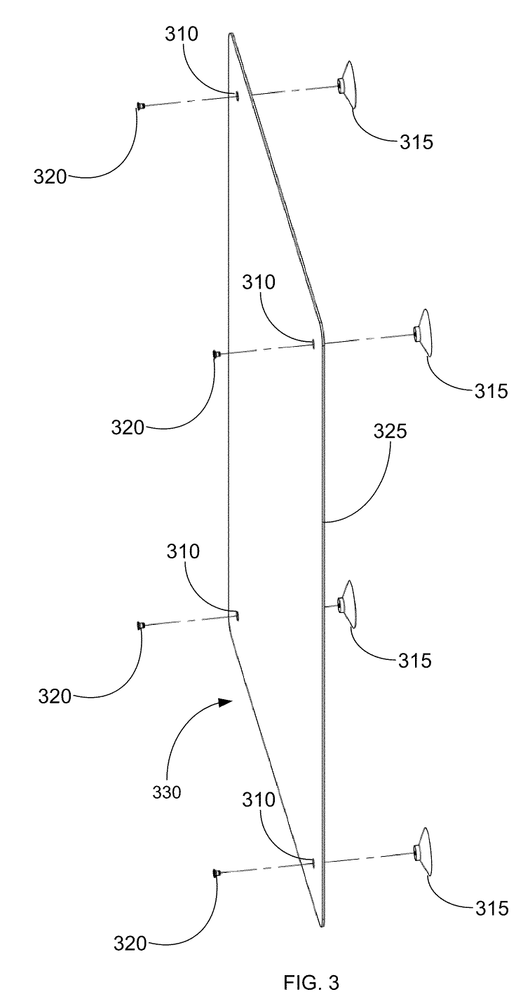

As shown in FIG. 3, in an exemplary embodiment, the attachment means can be one or more suction cups 315 and the fastening means can be screws 320. In some embodiments, the screws 320 can be #8 oval head sheet metal screws, though other fasteners are contemplated. In an exemplary embodiment, the board element 330 can further comprise one or more mounting holes 310. In some embodiments, the number of suction cups 315, screws 320, and mounting holes 310 can be four.

The screws 320 can pass through the mounting holes 310 in the board element 330 and be threaded into the suction cups 315. This can enable the suction cups 315 to be firmly affixed to the second surface 325 of the board element 330. In some embodiments, screws 320 can further enable the suction cups 315 to be removed for cleaning, replacement, and/or convenient storage. In other embodiments, the suction cups 315 can be affixed to the second surface 325 of the board element 330 using a suitable adhesive means such as, for example and not limitation, glue, epoxy, or double stick tape. The use of adhesives can obviate the need for screws 320 and mounting holes 310 and enable direct attachment of the suction cups 315 to the board element 330.

In still other embodiments, the fastening means 320 can comprise studs welded or adhered to the second surface 325 of the board element 330. The studs can be, for example and not limitation, spot welded, TIG welded, MIG welded, or adhered to the board element 330 using two-part epoxy or other suitable means. This can preclude the need for mounting holes 310 and provide a substantially smooth first surface 305 for the board element 330. This can increase the usable area provided by the first surface 305 of the board element 330.

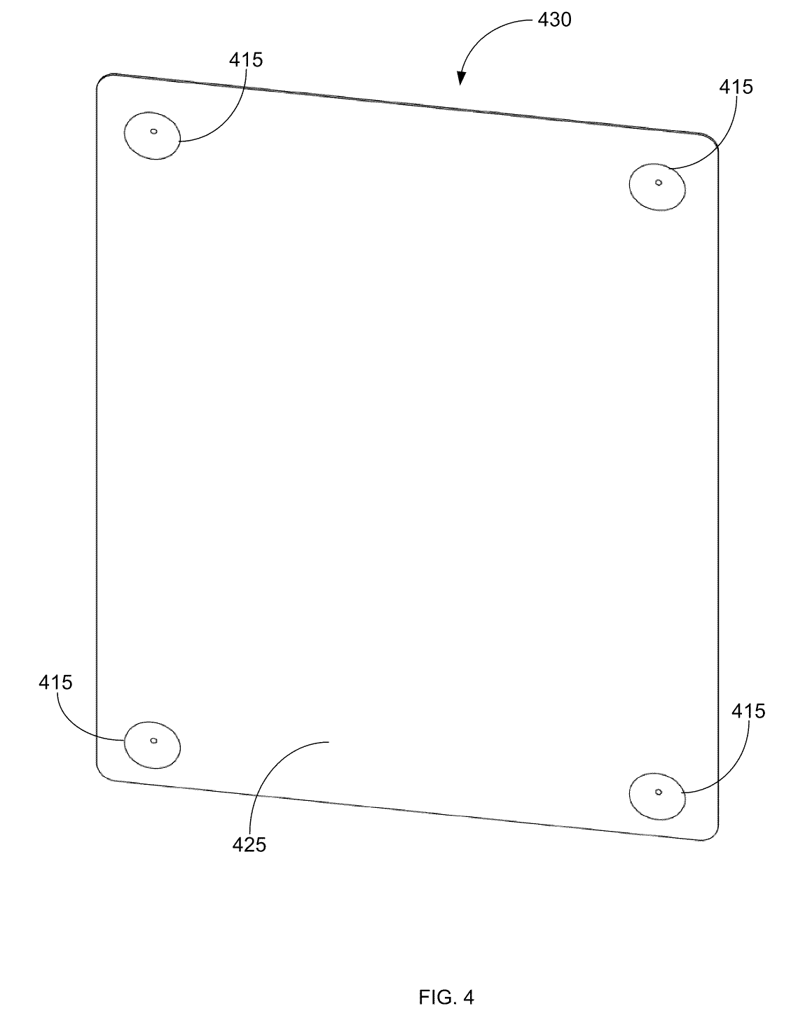

FIG. 4 depicts suction cups 415 mounted to the second surface 425 of the board element 430 in accordance with some embodiments of the present invention. In an exemplary embodiment, four suction cups 415 placed at the corners or the board element 430 can be used. This can enable all four corners of the board element 430 to be securely affixed to the desired surface. Other configurations are contemplated, however, and can vary depending on, among other things, the shape of the board element 430 and the holding power of the individual attachment means chosen. So, for example, one could use suctions cups 415 of sufficient strength to enable the use of two suction cups 415 placed in the vertical centerline of the board element 430. Alternatively, in a triangular embodiment of the board element 430, for example, three suctions cups 415 can be used.

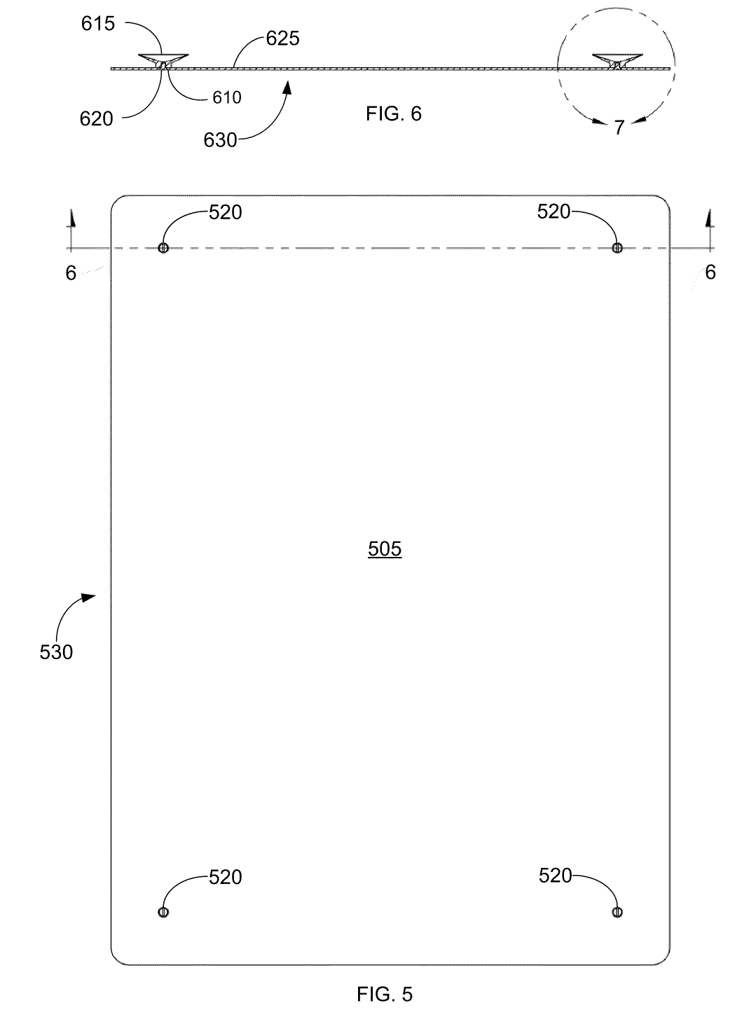

FIG. 5 depicts the first surface 505 of the board element 530 with flat-head mounting screws 520 inserted through the mounting holes (not shown) in the board element 530. As mentioned above, this configuration can vary depending on the shape of the board element 530 and attachment means employed. FIG. 6 is a cross-sectional view of the suction cups 615 mounted to the second surface 625 of the board element 630. Fasteners 620 have been inserted through mounting holes 610 and threaded into the suctions cups 615 affixing them thereto.

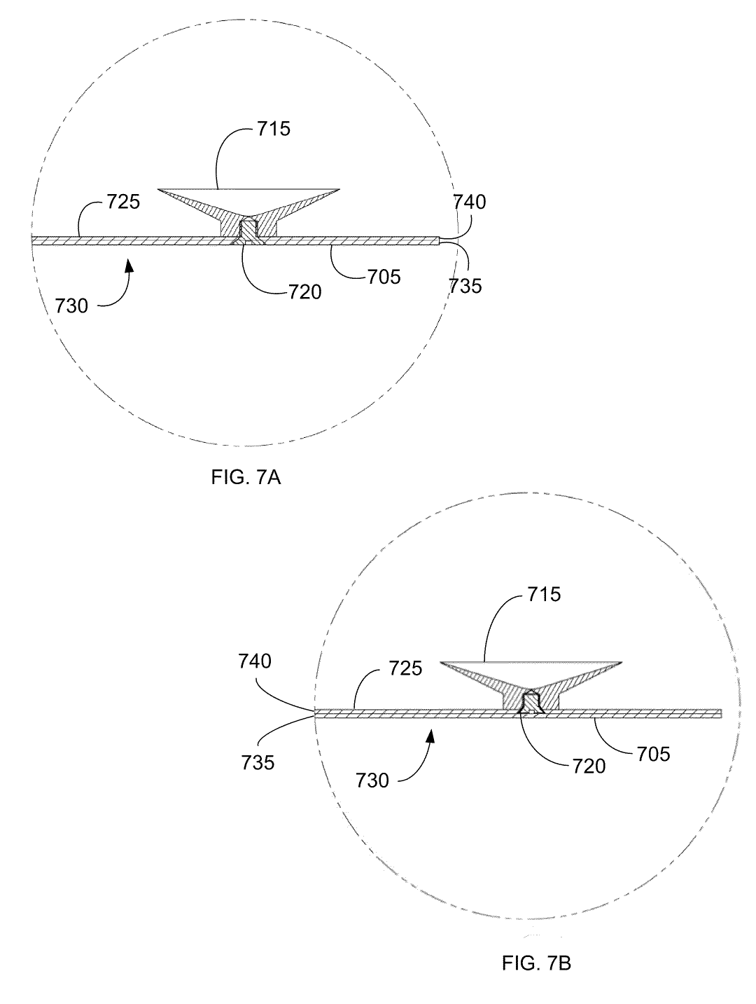

FIG. 7A is a cross-sectional, detail view of one of the suction cups 715 mounted to the second surface 725 of the board element 730 using fasteners 720. In some embodiments, the board element 730 can comprise a sheet of mild or carbon steel. In an exemplary embodiment, the board element can comprise 22-gauge sheet metal, though other gauges are contemplated. Mild steel is highly magnetic and provides a balance between brittleness and ductility. The can enable the board element 730 to deflect slightly during use without breaking while still being stiff enough to resist deformation.

In other embodiments, the board element 730 can be formed from a composite of steel and another suitable material, such as, for example and not limitation, wood, plastic, melamine, or cardboard. This can enable a thinner gauge of sheet metal to be used while still maintaining the necessary stiffness. This can be desirable to lower production costs due to the high cost of steel. In some embodiments, the first composite layer 735 can comprise steel to present a magnetic surface to the user and the second composite layer 740 can be another suitably rigid material, though other composite configurations are contemplated.

In some embodiments, shown in FIG. 7B, the fastener 720 can only extend through, and be flush mounted with, the second composite layer 740. The first composite layer 735 can then be attached to the second composite layer 740 in an overlying manner using, for example, adhesive, or other means that does not require fasteners 720. This can enable the first surface 705 to be substantially smooth and uninterrupted by fasteners 720 and increase the useable surface thereon.

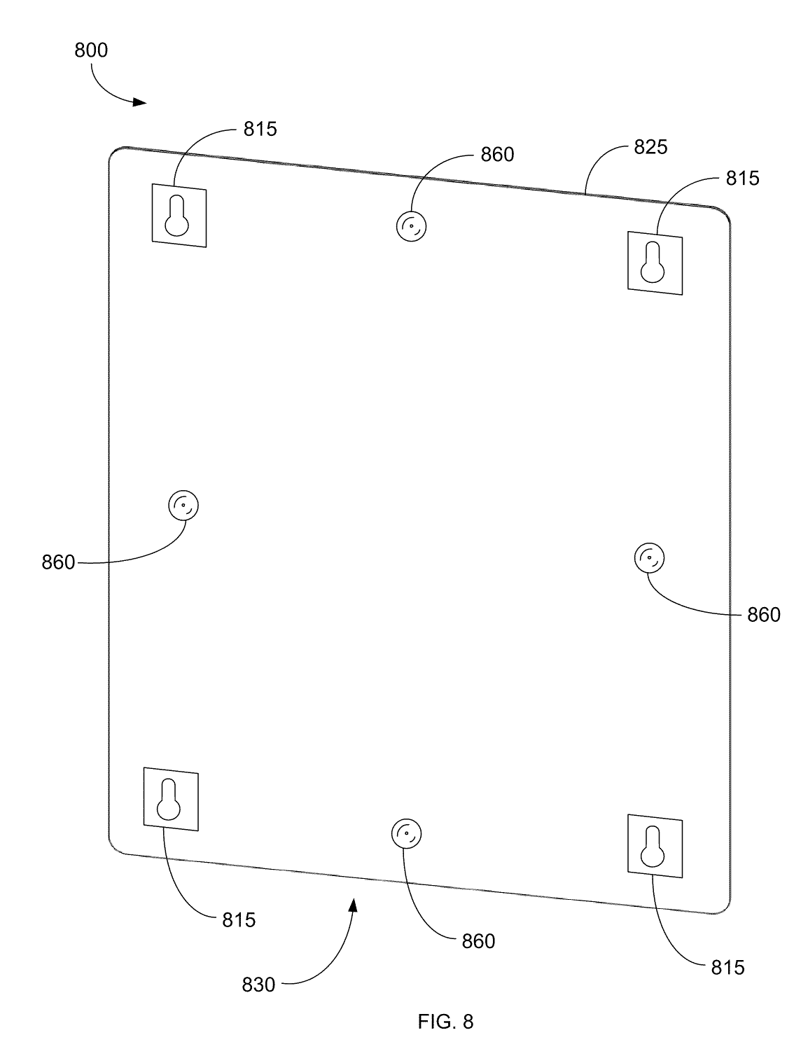

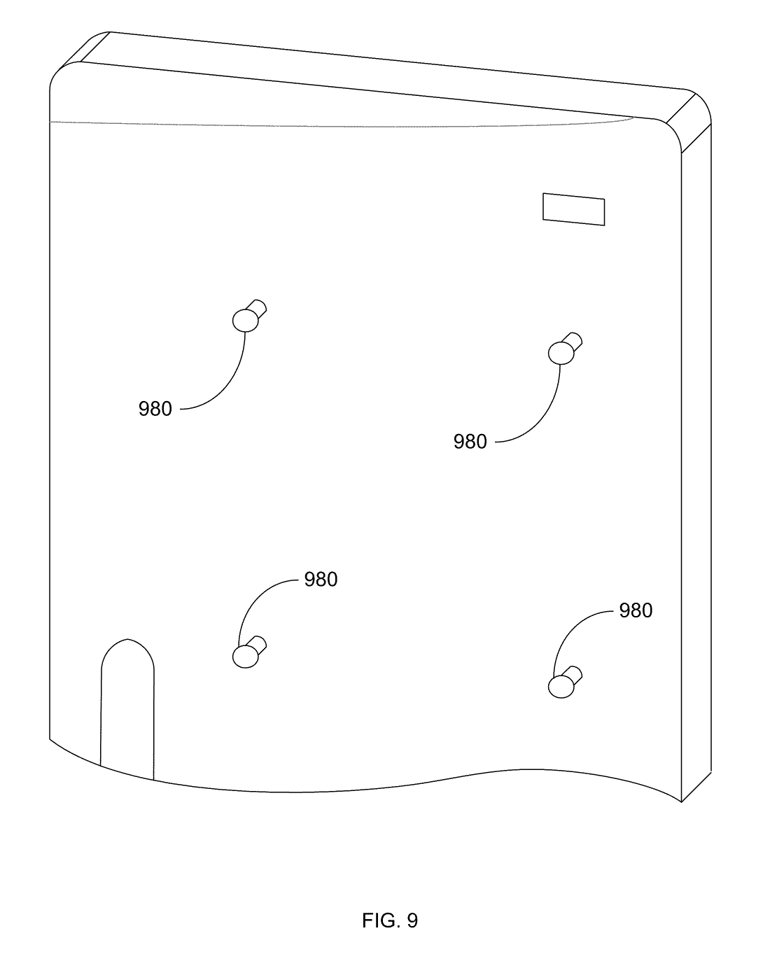

In still other embodiments, shown in FIGS. 8 and 9, the board element 830 can comprise attachment means 815 to coincide with manufacturer or dealer installed features or options. The attachment means can be, for example and not limitation, a key hole 815 and pin 980 type attachment means. This can enable relatively unobtrusive pins 980, or other means, to be provided on the appliance by the manufacturer, dealer, or aftermarket provider to be used to attach the device 800. In some embodiments, bumpers 860 made from, for example and not limitation, rubber, plastic, or foam can provide cushioning at the interface of the board element 830 and the appliance to prevent damage to the underlying surface. In other embodiments, the second surface 825 (not visible) of the board element 830 can be coated in, for example and not limitation, rubber, plastic, or felt to prevent the board element 830 from scratching the underlying surface. The device 800 can easily be removed leaving only the attachment pins 980 behind.

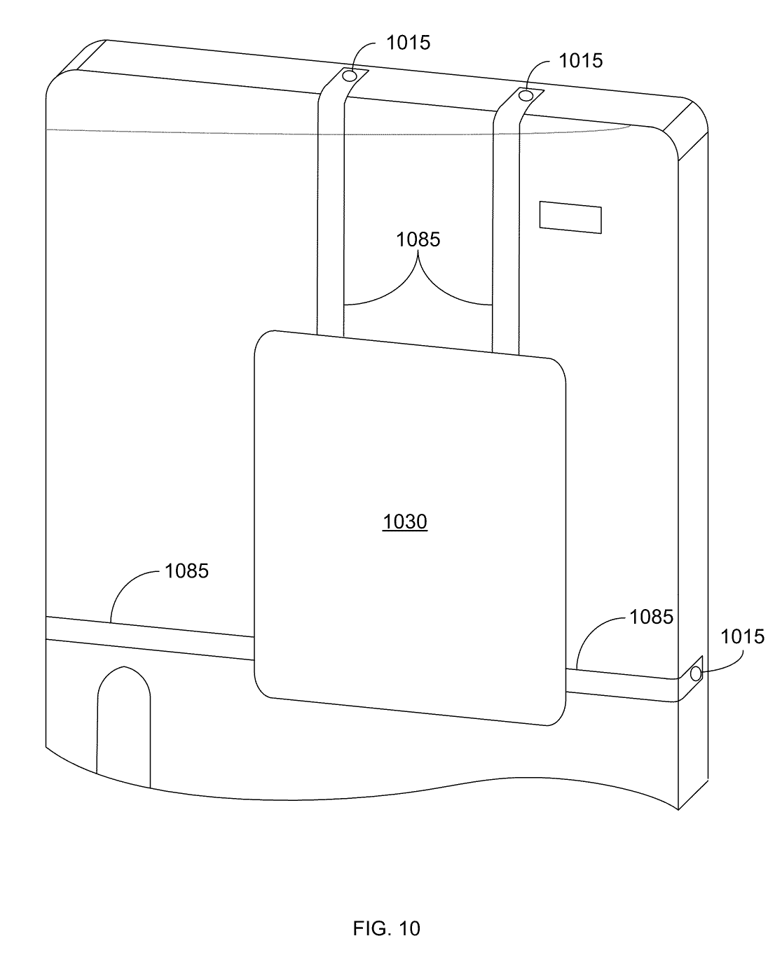

In still other embodiments, the attachment means 1015 can comprise, for example, snaps or pins, and can be provided on the edges of the appliance. See, FIG. 10. This can enable the board element 1030 to be removed while the attachment means on the appliance remain substantially out of sight. This feature can allow manufacturers, retailers, or aftermarket providers to offer consumers an accessory that provides a removable magnetic and/or dry erase surface on stainless steel appliances, other appliances, or surfaces, that when removed, is all but invisible.

In some embodiments, the board element 1030 can be attached using, for example, nylon straps 1085. This can enable the board element 1030 to be attached, for example, to attachment means pre-installed on the edge of a door on an appliance. So, for example and not limitation, the board element 1030 can be provided with nylon straps 1085 which include snaps 1015, which can correspond to complementary snaps on the side of the refrigerator door.

This can enable the board element 1030 to be quickly and securely attached to the appliance, or other surface. On the other hand, when the board element 1030 is removed, the attachment means on the appliance are relatively hidden from view on the edge of the door. In other embodiments, the attachment means 1015 can comprise, for example and not limitation, magnets, hooks and eyes, pins, or buttons. In still other embodiments, the straps 1085 can comprise, for example and not limitation, metal brackets, or can comprise plastic, canvas, elastic, or leather straps.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, materials, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A device for providing a removable magnetic surface on a non-magnetic surface comprising:
a board element comprising a first surface and a second surface, the first surface and the second surface disposed on opposite sides of the board element; and
an attachment means for attaching the second surface to a non-magnetic surface in a removable, non-marring manner such that the second surface and the non-magnetic surface are disposed in a substantially parallel and opposing manner.

2. The device of claim 1, the board element further comprising steel.

3. The device of claim 1, the board element further comprising a first composite layer comprising steel, and a second composite layer comprising one or more layers comprising rigid, non-magnetic materials.

4. The device of claim 1, the attachment means comprising one or more suction cups affixed to the second surface of the board element.

5. The device of claim 1, the attachment means comprising a removable adhesive.

6. The device of claim 1, the first surface, the second surface, or both further comprising a smooth, non-porous coating.

7. The device of claim 1, the attachment means comprising one or more hooks.

8. The device of claim 1, the board element comprising one or more shapes selected from the group consisting of a polygon, a circle, a star, a heart, capital letters, lower case letters, and an oval.

9. The device of claim 1, further comprising one or more fasteners inserted through one or more mounting holes in the board element for affixing the attachment means to the second surface of the board element.

10. A device for providing a removable magnetic surface on a non-magnetic surface comprising:
a board element comprising a first surface and a second surface, the first surface and the second surface disposed on opposite sides of the board element; and
an attachment means, for attaching the second surface to corresponding attachment means installed on a non-magnetic surface, such that the second surface and the non-magnetic surface are disposed in a substantially parallel and opposing manner.

11. The device of claim 10, the attachment means selected from the group consisting of snaps, pins, hooks and eyes, magnets, and Velcro.

12. The device of claim 10, the attachment means further comprising one or more attachment straps.

13. The device of claim 12, the attachment straps comprising one or more materials selected from the group consisting of nylon, canvas, metal, plastic, or elastic.

14. A method for providing a magnetic surface on a non-magnetic surface comprising:
providing a board element with a first surface and a second surface;
covering one or both of the first surface and the second surface with a smooth, non-porous coating; and
providing an attachment means for detachably affixing the second surface of the board element to a non-magnetic surface.

15. The method of claim 14, the board element further comprising steel.

16. The method of claim 14, further comprising:
providing a first composite panel comprising steel;
providing a second composite panel comprising one or more rigid, non-magnetic materials; and
affixing the first composite panel to the second composite panel to form the board element.

17. The method of claim 14, the attachment means comprising one or more suction cups.

18. The method of claim 14, the smooth, non-porous coating selected from the group consisting of powder-coating, paint, plastic, enamel, melamine, ceramic, zinc, aluminum, nickel, and chrome.

19. The method of claim 14, the fastening means comprising a non-permanent adhesive.

20. The method of claim 14, the smooth, non-porous surface compatible for use with dry erase marking utensils.
